(19) United States
(12) Patent Application Publication
(10) Pub. No.: US 2005/0091148 A1
(43) Pub. Date: Apr. 28, 2005

(54) Method and apparatus for synthesizing metrics of stock or share market indices

(76) Inventor: Anthony Rotondo, Clear Island Waters (AU)

Correspondence Address: Edmund P. Pfleger;Grossman Tucker Perreault & Pfleger, PLLC, 55 South Commercial Street, Manchester, NH, 03101, US

(21) Appl. No.: 10/974,396

(22) Filed: Oct. 27, 2004

(30) Foreign Application Priority Data
Oct. 27, 2003 (AU) 2003905889

(51) Int. Cl. G06F 17/60

(52) U.S. Cl. 705/37

(57) ABSTRACT

A method of synthesizing metrics for a predetermined group of securities, said method comprising the steps of obtaining trade information for each security of the predetermined group of securities, the trade information suitably including for each trade an identifier for the security, the unit price, time of trade and volume of securities traded; accumulating said trade information for a desired time period and periodically storing the accumulated trade information in a store; calculating from the accumulated trade information a metric for said predetermined group of securities; and determining a standardised statistical measure, preferably a Z score, of said metric utilising the accumulated trade information stored in the time period. An apparatus for implementing the product and a computer software product containing instructions for execution of the method are also disclosed.

### CROSS-REFERENCE TO RELATED APPLICATIONS

This application claims the benefit of Australian Provisional Patent Application No. 2003905889 filed Oct. 27, 2003, which application is herein incorporated by reference in its entirety.

### BACKGROUND OF THE INVENTION

1. Field of the Invention

The present invention relates to computerised collection, analysis and display of stock or share market data. In particular, the present invention relates to a method and apparatus for observing the aggregate trading behaviour of a group of securities, such as represented by a stock index, that are recurrently traded on a stock exchange or share market. More particularly, although not exclusively, the invention is concerned with synthesizing metrics, such as market depth, of share market indices.

2. Discussion of the Background Art

Stock indices measure the movement in share values or in derivative products, such as futures, warrants and options, resulting from trading on a stock exchange, and are generally calculated by an independent agency, such as Standard & Poors. The indices typically group securities according to either market capitalization or industry sector.

On the Australian Stock Exchange (ASX) the market capitalization indices include the ASX 50, ASX 100 and ASX 200, together with the All Ordinaries which cover the top 500 Australian public companies; whilst the market sector indices include those for the energy, financial, information technology and health care industries. Derivative products may also be tracked via indices such as the ASX 200 Mini Index Futures, the ASX 200 Index Calls & Puts, and the ASX 50 Instalments.

The present applicant's earlier Australian Patent Application No. 2003 203434 entitled “Method, system and computer program for observing the trading behaviour of a security”, which is hereby incorporated by reference, is concerned with both observing present and predicting future trading behaviour of individual securities. Statistical information or metrics about trading behaviour of individual securities, such as trade count, money flow and market depth, may be conveniently extracted or calculated from trade data for each security or derivative as supplied by a stock exchange, such as the ASX, utilizing the applicant's earlier invention.

However, statistical information about the trading behaviour of an aggregated group of securities, other than reflected in movement of the point values of respective market indices, is not presently available. One reason for this is that buying and selling prices for individual securities within a particular index can be different over a number of trading sessions. Other reasons include technical difficulties with speed, reliability and availability of exchange traded data. Furthermore, recent advances in the computational ability of computers has now made it commercially realistic to collect, aggregate and analyse this data in real-time.

U.S. Patent Application Publication No. 2003 0046215 entitled “Market indicator process and method” by Teague describes a process for predicting an opening price of a security index wherein a trade monitoring process monitors at least a portion of the trading of the discrete securities that occur outside a regular trading session, such as overnight. Whilst this application describes processes for calculation of closing and current index market capitalisation, there is no teaching that these processes should occur in real time and be utilised during the regular trading session.

U.S. Patent Application Publication No. 2003 0069834 entitled “Securities market and market maker activity tracking system and method” by Cutler describes a system to monitor securities market activity wherein level 1 or level 2 for individual securities is analysed to derive indicators of momentary upward or downward price pressure, which indicators are displayed with each selected security to a user.

However, the Cutler application is also concerned about market makers and tracking their activities—a concept quite different to the present invention.

### SUMMARY OF THE INVENTION

Object of the Invention

The applicant considers it desirable to generate metrics for a group of securities, such as contained in a market index, for share trading and stock market analysis purposes.

Disclosure of the Invention

Accordingly the present invention provides, in one broad aspect, an apparatus for synthesizing metrics for a predetermined group of securities, said apparatus comprising:
an interface for obtaining trade information for each security of the predetermined group of securities;
an accumulator coupled to the interface for accumulating said trade information for a desired time period;
a store coupled to the accumulator in which store the accumulated trade information is periodically stored; and
a processor coupled to the store, said processor including instructions for
   calculating from the accumulated trade information a metric for said predetermined group of securities, and
   determining a standardised statistical measure of said metric utilising the accumulated trade information stored in the time period.

Preferably the interface is coupled to a stock exchange or authorised data vendor computer system for obtaining trade information in real time.

Suitably, the trade information including for each trade an identifier for the security, the unit price, time of trade and volume of securities traded.

If required, determination of the standardised statistical measure further utilises accumulated trade information stored over a number of earlier time periods.

In another broad aspect of the invention, there is provided a method of synthesizing metrics for a predetermined group of securities, said method comprising the steps of:
obtaining trade information for each security of the predetermined group of securities;
accumulating said trade information for a desired time period and periodically storing the accumulated trade information in a store;
calculating from the accumulated trade information a metric for said predetermined group of securities; and
determining a standardised statistical measure of said metric utilising the accumulated trade information stored in the time period.

Suitably the predetermined group of securities corresponds to a selected stock index, such as an index based on market capitalisation or industry sector of the respective companies.

The trade information desirably includes, for each trade, an identifier for the security, the unit price, time of trade and volume of securities traded.

Preferably the metric for the group of securities is selected from the group including trade count, money flow and, most preferably, buy and sell market depth.

Preferably the standardised statistical measure is a Z score.

Suitably the trade information is obtained from a stock exchange, an electronic clearing house, or from an authorised third party data vendor. Most suitably the synthesis method is conducted in real time, utilising live trade information obtained from a computer system operated by the stock exchange or authorised data vendor.

Suitably the desired time period ranges from about 1 minute up to 20 minutes, preferably being 5 minutes in duration.

If required, the method may include the further step of producing a display of the standardised statistical measure, suitably compared with statistical measures obtained in a number of earlier time periods. The number of earlier time periods is desirably chosen to be statistically significant, in the context of said measure. For example the earlier time periods may extend over several trading sessions or over several weeks.

In a further broad aspect, the invention provides a computer software product comprising instructions stored on computer readable media and executable by a processor for synthesizing metrics for a predetermined group of securities, said instructions for performing the steps of:
obtaining trade information for each security of the predetermined group of securities, the trade information suitably including for each trade an identifier for the security, the unit price and volume of securities traded;
accumulating said trade information for a desired time period and periodically storing the accumulated trade information in a store;
calculating from the accumulated trade information a metric for said predetermined group of securities; and
determining a standardised statistical measure of said metric utilising the accumulated trade information stored over a statistically significant number of earlier time periods.

### BRIEF DETAILS OF THE DRAWINGS

In order that this invention may be more readily understood and put into practical effect, reference will now be made to the accompanying drawings illustrate preferred embodiments of the invention, and wherein:

FIG. 1 is a diagram schematically illustrating the apparatus of a first embodiment of the invention;

FIG. 2 is flowchart illustrating the steps in the method of the first embodiment;

FIG. 3 is a diagram illustrating results obtained by the first embodiment; and

FIGS. 4 to 10 are plots of prior art reports capable of generation by use of the present invention.

### DESCRIPTION OF EMBODIMENTS OF THE INVENTION

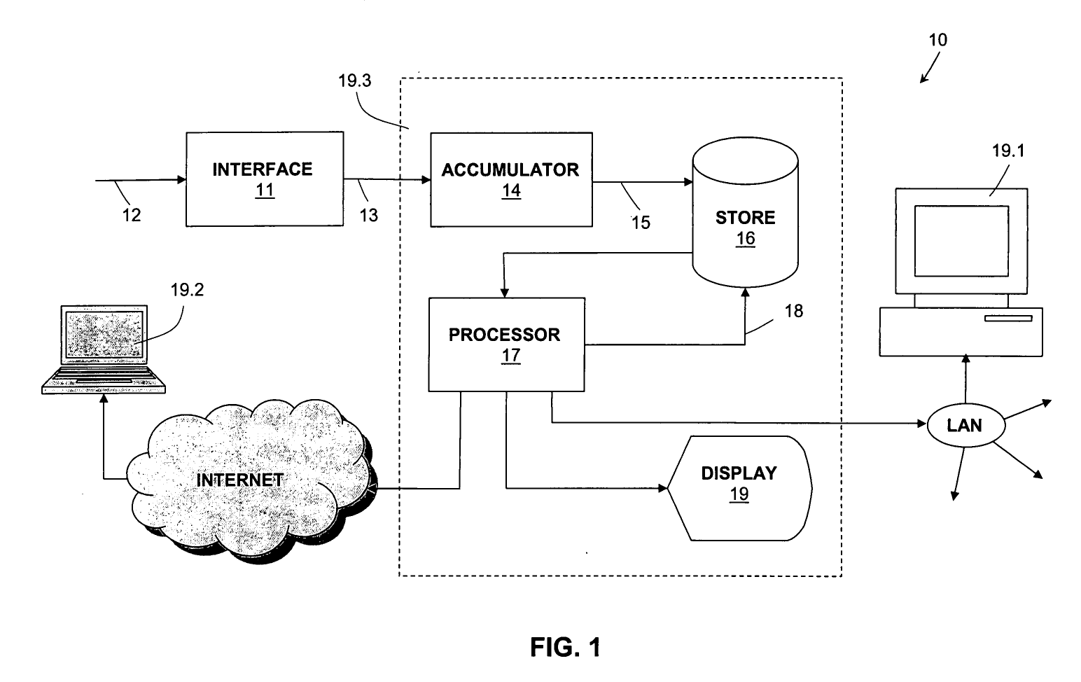

Referring to FIG. 1, there is shown an apparatus 10 of a first embodiment for synthesizing metrics for a predetermined group of securities. The apparatus includes an interface 11, such as a modem or similar input/output device, for coupling the apparatus to a live feed 12 of stock market data provided via a communications link.

The market data typically includes trade information 13 wherein the volume, unit buying or selling price and security identifier for each trade is provided in substantially real time, from a stock exchange or an electronic clearing house such as employed by NASDAQ (not shown), over the communications link. In the present embodiment, the communications link comprises a secure channel provided in a packet switched communications network, such as the Internet. It will be appreciated that trade information may alternatively be sourced from a third party data vendor such as eSignal, Reuters or Bloomberg.

The trade information 13 obtained from the live feed 12 is sent to an accumulator 14 which accumulates the volume and price for all buy and sell transactions involving each security over a time period of about five (5) minutes. The accumulation time period is suitably anywhere in the range from one (1) minute to twenty (20) minutes in duration. At the end of this five minute time period, the accumulated trade information 15 for each security is stored in on-line store 16, such as a magnetic disc system.

The accumulator 14 suitably continues accumulating and periodically storing the trade information continuously during normal stock market trading hours, in Australia being from 10:00 to 16:00. In a variation of the present embodiment, the accumulator may also accumulate in selected storage locations provided by the store 16, the results of certain relatively simple metrics. For example metrics such as trade count and money flow may be calculated for most popular groups of securities, which might be typified by key stock market indices.

The accumulated trade information 15 may then be employed by a processor 17 to calculate a variety of metrics for predetermined groups of securities, as required. The metric of interest in the present embodiment is that of market depth, wherein all the buy and sell data is aggregated from the trades in the predetermined group of stocks that comprise an index, for example the ASX 200 index. The results for aggregated market depth metric 18 may be stored in the on-line store 16, suitably in a database construct for ease and speed of access.

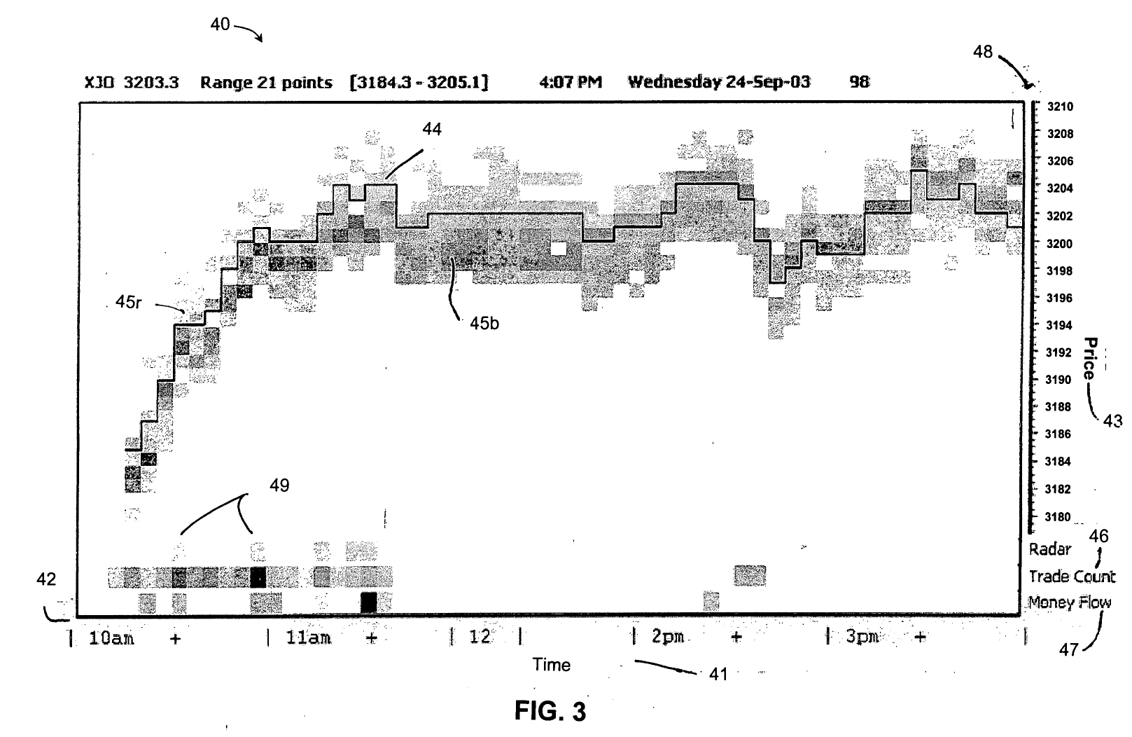

Storage of the aggregated results allows standardisation of market depth results in either a current time period or over a daily trading session. In the resent embodiment, the data is standardised by calculating the mean and standard deviation from a set of market depth data, namely the market depth data observed in the current time period. In another embodiment, the aggregated results may be standardised by calculating the mean and standard deviation from a statistically significant set of historical market depth data, for example over two (2) weeks or 720 time periods (i.e. 10 days×6 hour trading session×12 five minute periods). The processor 17 is also coupled to a display 19 enabling display of results in a desired format, for viewing. One preferred display format will be discussed further below in relation to FIG. 3.

It will be appreciated that, in other embodiments of the present invention, the display 19 may be a component of an end-user personal computer interface device, such as a desktop computer 19.1 or a personal digital assistant (PDA) 19.2, that may be coupled to the processor 17. In this embodiment, the processor 17 may be a component of a computer database server 19.3, wherein a plurality of end user interface devices may be coupled via such communications links. The database server of the embodiment comprises an Intel Pentium 2.4 Ghz processor, 512 MB of random access memory (RAM), utilising Microsoft's Windows XP operating system and Microsoft's SQL Server 7.0.

The communications link may take the form of a channel provided in a local area network (LAN), a metropolitan area network (MAN) or a wide area network (WAN), or a global public network such as the Internet. A 512 kbps Internet connection links the server to the data vendor, such as esignal, supplying trade information. The vendor's data format can facilitate efficient information processing, and esignal is presently preferred as they provide direct access to their data warehouse. User requests for particular statistical information may be routed to the processor 17 via a suitable end user application, utilising input selection means such as keypads, keyboards or pressure sensitive tablets provided by a remote desktop computer or PDA.

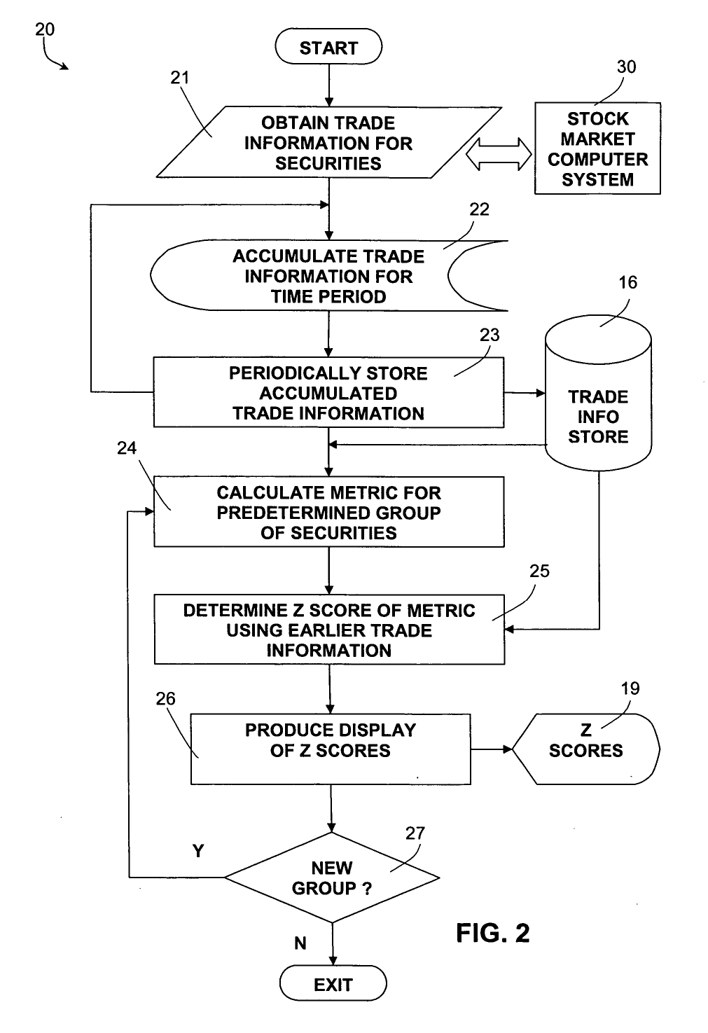

FIG. 2 illustrates an overview flowchart of the synthesis method 20 of the embodiment. In step 21, trade information for securities is obtained by live feed from the stock market computer system 30, which trade information is accumulated in step 22 for each security over a predetermined time period. The accumulated trade information for respective securities is periodically stored in step 23 in a trade information store 16. This cycle of accumulation of trade information continues during each daily trading period.

The end of each five (5) minute accumulation period conveniently triggers the calculation of metrics for a predetermined group of securities in step 24. In one example, the metrics of money flow, trade count and market depth are calculated. A statistical measure in the nature of a Z score for each metric is determined in step 25, by standardising each metric utilising 720 earlier time periods (or two weeks) of accumulated trade information for the corresponding group of securities.

The market depth 45 values are obtained by aggregating the dollar value (price×volume) buy limit orders and sell limit orders in 1 cent increments either side of the last traded price for each stock that makes up the index. In this example a range of five (5) cents above and below the last traded price has been used for each stock, allowing the generation of 5 levels of market depth 45 above and below the trace 44. These values for the 200 stocks that make up the ASX 200 (identified as “XJO”) are summed together in each of their one (1) cent increments levels and you are left with ten (10) values. From these ten values for the current time period, the mean and standard deviation are calculated and the Z scores determined for the market depth 45 to be displayed above and below the trace 44. In other examples, 10 cent increments may be employed (such as for the NASDAQ) and larger increments are expected to be appropriate for larger stock exchanges (such as the NYSE). The increments are suitably chosen relative to the typical stock price range. The majority of Australian stocks trade at below A$10, whereas the majority of US stocks trade above US$20.

In step 26, the resultant Z scores are used to produce a display, such as the chart 40 depicted in FIG. 3, wherein a series of Z scores is shown, each score determined for a respective 5 minute period in the current trading session. The Z scores are suitably colour coded on the chart to allow comparison of historical data with current trading behaviour during the session, wherein the time of day 41 is shown on a horizontal axis 42, and points 43 with trace 44 and superimposed market depth 45, together with trade count 46 and money flow 47 indicators on a vertical axis 48.

In the chart 40, the aggregated buy orders appear in a first colour 45b (for example blue) and extend below the price trace 44, whilst the aggregated sell orders appear in a second colour 45r (for example red) and extend above the trace. It will be appreciated that the intensity of the colour may vary in accordance with the relative number of buy or sell orders presently in the market. When the metric is presented in this way, it is apparent to a viewer that the more buy market depth there is the greater the likelihood of a rising market.

It will also be noted that there is also a higher trade count and money flow when the market (at least for the shares in the index) is rising, since these indicators correspond to the upward sloping portions of the price trace 44. The radar indications 49, which appear on the chart from 10:30 onwards, are indicative of the presence of unusual trading activity, in this case relatively heavy buying. The chart of the present embodiment commences at 10:30 because Australia randomly staggers the start of trading within a 15 minute period after 10:00, allowing trading to settle after the initial flurry.

Whilst steps 23 and 24 are linked in the method illustrated FIG. 2, it will be appreciated that steps 21 to 23 may be a self-contained sub-process, separate from steps 24 to 27, in an alternative embodiment of the method of the invention.

The method and apparatus of the invention provide a number of important advantages over present stock market analysis systems, in that the aggregation of all trades for the group of stocks making up a particular index allows metrics to be generated that it is believed are not currently available for indices. In particular, the aggregation of market depth of the stocks making up an index is not known to be previously available at all.

All analysis in the stock market is based on mathematical calculations. To assist the non-mathematician participants in the market to interpret the results the calculation are usually overlaid on a stock price chart. Most mathematical techniques used for analysis of price and volume use either standard statistical techniques or some formula generated from empirical analysis which results in a new time-series which is displayed on a price chart. These time-series are commonly referred to as line studies.

There are 5 main methods to display these time-series:

1. a line study overlayed on a price chart;

2. a line study displayed below a price chart;

3. symbols on the price chart;

4. colour coded bars eg. “Candle sticks”; and

5. background colouring.

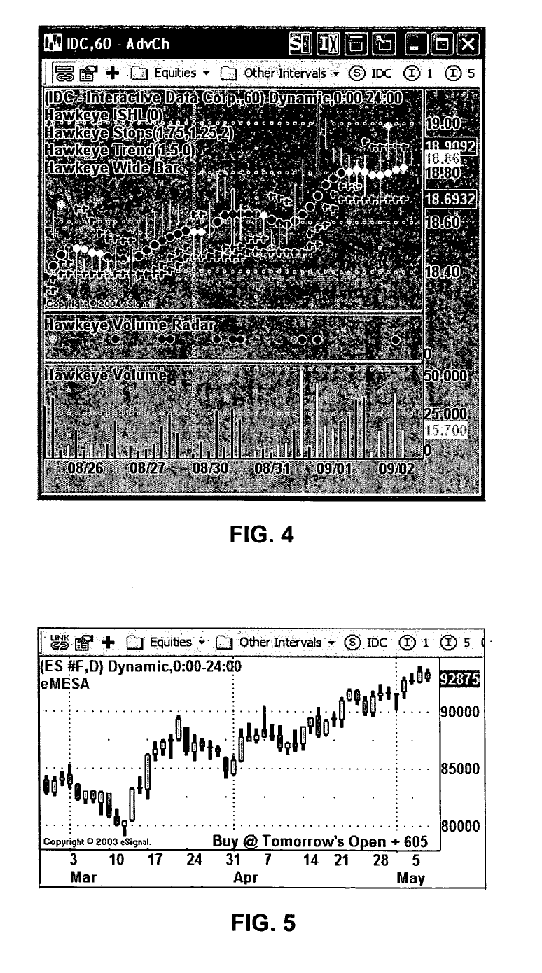

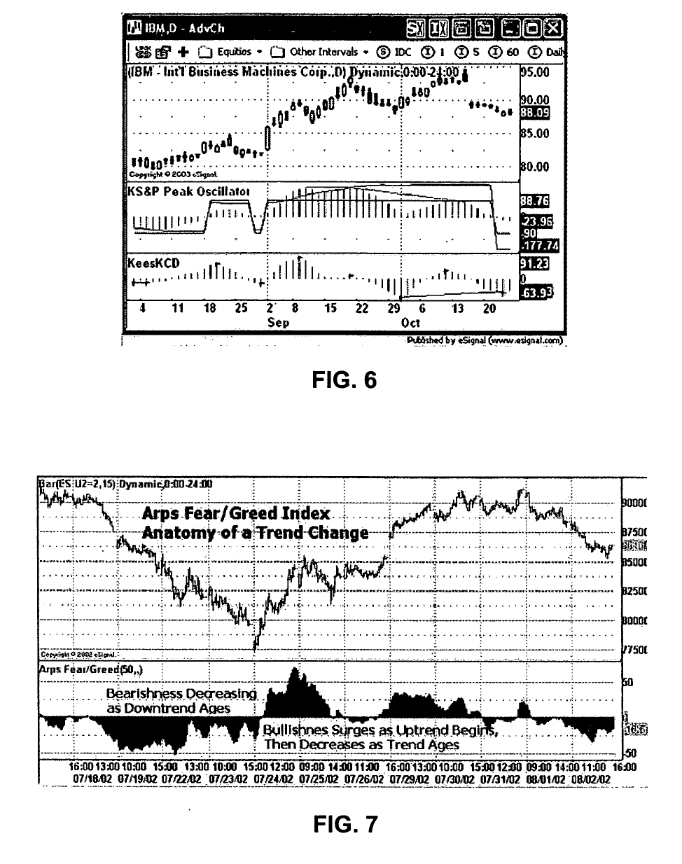

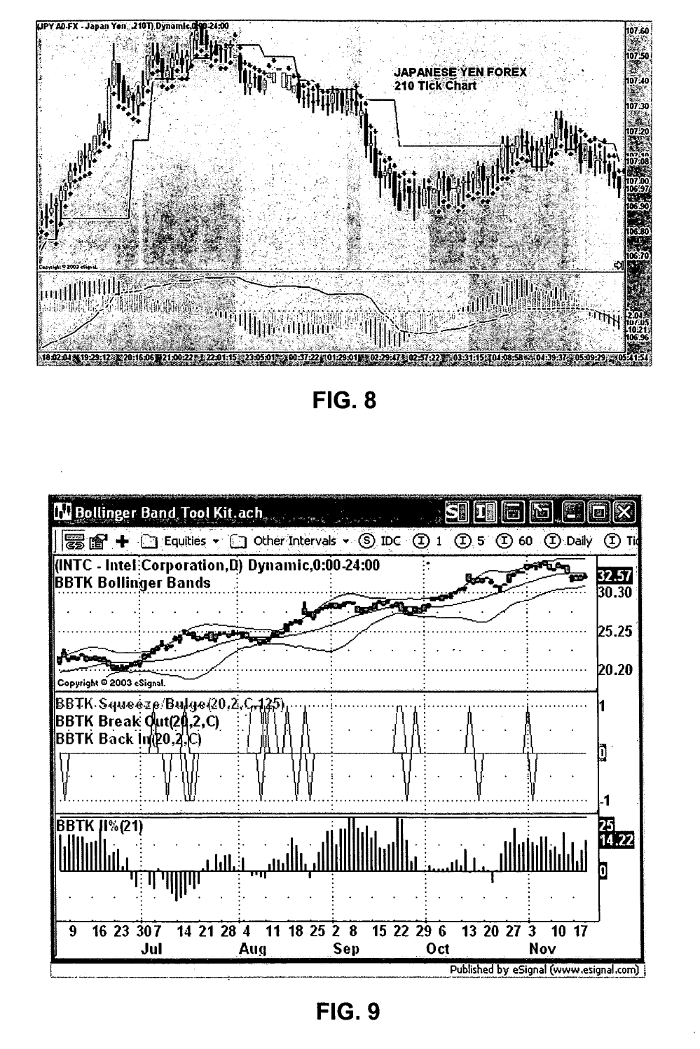

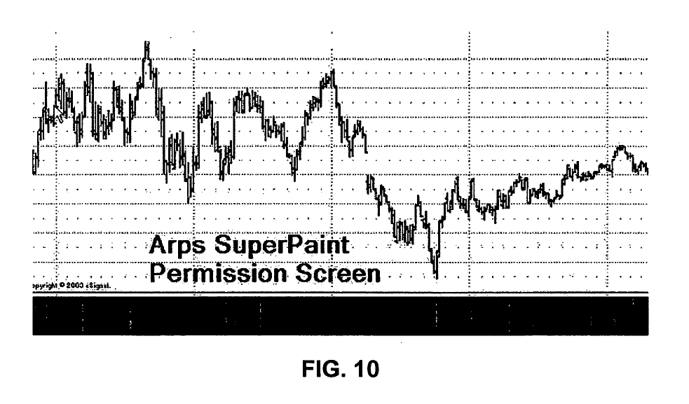

FIGS. 4 to 10 provide some examples of each of the display methods. FIG. 4 is an example embodying methods 2, 3 and 4. FIG. 5 is an example embodying method 4. FIG. 6 is an example embodying methods 2 and 4. FIG. 7 is an example embodying method 2. FIG. 8 is an example embodying all of methods 1 to 5. FIG. 9 is an example embodying methods 1, 2 and 4. FIG. 10 is an example embodying method 2.

The results of the method performed according to the present invention may readily be encoded into a time-series and displayed with one or more of the methods above. The generation of such a display may be transparent to the user, in that knowledge of the use of the present invention is not necessary for the reader of the displayed data.

There are various ways for the resulting statistics generated by the invention to be presented/displayed/communicated to the user that are different to the display method contained in the current specification of the invention.

It is to be understood that the above embodiments have been provided only by way of exemplification of this invention, and that further modifications and improvements thereto, as would be apparent to persons skilled in the relevant art, are deemed to fall within the broad scope and ambit of the present invention set out in the claims which follow.

1. An apparatus for synthesizing metrics for a predetermined group of securities, said apparatus comprising:
an interface for obtaining trade information for each security of the predetermined group of securities;
an accumulator coupled to the interface for accumulating said trade information for a desired time period;
a store coupled to the accumulator in which store the accumulated trade information is periodically stored; and
a processor coupled to the store, said processor including instructions for
calculating from the accumulated trade information a metric for said predetermined group of securities, and
determining a standardised statistical measure of said metric utilising the accumulated trade information stored in the time period.

2. The apparatus as claimed in claim 1 wherein the interface is adapted for coupling to a stock exchange or authorised data vendor computer system to obtain the trade information in real time.

3. The apparatus as claimed in claim 1 wherein the trade information includes for each trade an identifier for the security, the unit price, time of trade and volume of securities traded.

4. The apparatus as claimed in claim 1 wherein determination of the standardised statistical measure further utilises accumulated trade information stored in the accumulator over a number of earlier time periods.

5. A method of synthesizing metrics for a predetermined group of securities, said method comprising the steps of:
obtaining trade information for each security of the predetermined group of securities;
accumulating said trade information for a desired time period and periodically storing the accumulated trade information in a store;
calculating from the accumulated trade information a metric for said predetermined group of securities; and
determining a standardised statistical measure of said metric utilising the accumulated trade information stored in the time period.

6. The method claimed in claim 5 wherein the predetermined group of securities corresponds to a selected stock index.

7. The method of claim 6 wherein the selected stock index is based on market capitalisation or industry sector of the respective securities included in said stock index.

8. The method of claim 5 wherein the trade information includes for each trade an identifier for the security, the unit price, time of trade and volume of securities traded.

9. The method according to claim 5 wherein the metric for the group of securities is selected from the group including trade count, money flow, buy market depth and sell market depth.

10. The method according to claim 5 wherein the standardised statistical measure is a Z score.

11. The method accordingly to claim 5 wherein the trade information is obtained from a stock exchange or authorised data vendor.

12. The method according to claim 11 wherein the synthesis method is conducted in real time, utilising live trade information obtained from a computer system operated by the stock exchange or the authorised data vendor.

13. The method of claim 5 wherein the desired time period ranges from about 1 minute up to 20 minutes.

14. The method of claim 5 wherein the desired time period is 5 minutes in duration.

15. The method of claim 5 further comprising the step of producing a display of the standardised statistical measure compared with statistical measures obtained in a number of earlier time periods.

16. The method of claim 15 wherein the number of earlier time periods is desirably chosen to be statistically significant in the context of said standardised measure.

17. A computer software product comprising instructions stored on computer readable media and executable by a processor for synthesizing metrics for a predetermined group of securities, said instructions for performing the steps of:
obtaining trade information for each security of the predetermined group of securities;
accumulating said trade information for a desired time period and periodically storing the accumulated trade information in a store;
calculating from the accumulated trade information a metric for said predetermined group of securities; and
determining a standardised statistical measure of said metric utilising the accumulated trade information stored over a statistically significant number of earlier time periods.

18. The computer software product of claim 17 wherein the predetermined group of securities corresponds to a selected stock index.

19. The method of claim 18 wherein the selected stock index is based on market capitalisation or industry sector of the respective securities included in said stock index.

20. The method of claim 17 wherein the trade information includes for each trade an identifier for the security, the unit price, time of trade and volume of securities traded.

21. The method according to claim 17 wherein the metric for the group of securities is selected from the group including trade count, money flow, buy market depth and sell market depth.

22. The method according to claim 17 wherein the standardised statistical measure is a Z score.
